(19) United States
(12) Patent Application Publication
(10) Pub. No.: US 2025/0325994 A1
(43) Pub. Date: Oct. 23, 2025

(54) FLUID FLOW COMPONENT WITH BACKPRESSURE BOOSTER

(71) Applicant: HEN NOZZLES INC., Hayward, CA (US)

(72) Inventors: Dennis Joseph LeGear, Pleasant Hill, CA (US); Sunny Sethi, Castro Valley, CA (US); Nicholas James McKibben, Oakland, CA (US); Sagar Bhatia, Fremont, CA (US); Grant Harrison Friesen, Concord, CA (US)

(21) Appl. No.: 19/065,996

(22) Filed: Feb. 27, 2025

Related U.S. Application Data
(60) Provisional application No. 63/559,455, filed on Feb. 29, 2024.
(60) Provisional application No. 63/716,579, filed on Nov. 5, 2024.

(51) Int. Cl. B05B 1/34; A62C 31/03; B05B 1/30

(52) U.S. Cl. CPC B05B 1/3402; A62C 31/03; B05B 1/302

(57) ABSTRACT

A backpressure booster for a nozzle assembly for a firefighting apparatus is disclosed. The backpressure booster includes a housing, a flow restrictor within the housing, and flow conditioner within the housing and positioned downstream from the flow restrictor, where the flow conditioner is configured to direct fluid radially outward towards an inner surface of the housing.

### INCORPORATION BY REFERENCE

This application claims the benefit under 35 U.S.C. § 119 (e) to U.S. Provisional Application No. 63/559,455, entitled “FLUID FLOW COMPONENT WITH BACKPRESSURE BOOSTER,” filed Feb. 29, 2024, and to U.S. Provisional Application No. 63/716,579, entitled “FLUID FLOW COMPONENT WITH BACKPRESSURE BOOSTER,” filed Nov. 5, 2024, the entirety of each of which is hereby incorporated by reference herein.

### BACKGROUND

### Field

The field relates to nozzle assemblies for firefighting hoses.

### Description of the Related Art

Nozzle assemblies can be connected to a hose/fluid source and utilized to regulate and direct the flow of fluid therethrough. Such nozzle assemblies can be used, for example, by firefighters to dispense water or other firefighting fluids. However, it can be challenging for firefighters to control a hose and nozzle assembly during operation of the hose and nozzle assembly. Accordingly, there is a need for improved nozzle assemblies that improve the maneuverability and useability of the hose and nozzle assembly.

### BRIEF DESCRIPTION OF THE DRAWINGS

FIG. 1 is a perspective view of a nozzle assembly.

FIG. 2 is a cross-sectional view of the nozzle assembly of FIG. 1.

FIG. 3A is a perspective view of a backpressure booster, according to some embodiments.

FIG. 3B is an exploded view of the backpressure booster of FIG. 3A.

FIG. 3C is a perspective view of an alternative version of the backpressure booster of FIG. 3A, according to some embodiments.

FIG. 3D is a cross-sectional view of the backpressure booster of FIG. 3C.

FIG. 4 is a schematic cross-sectional view of the backpressure booster of

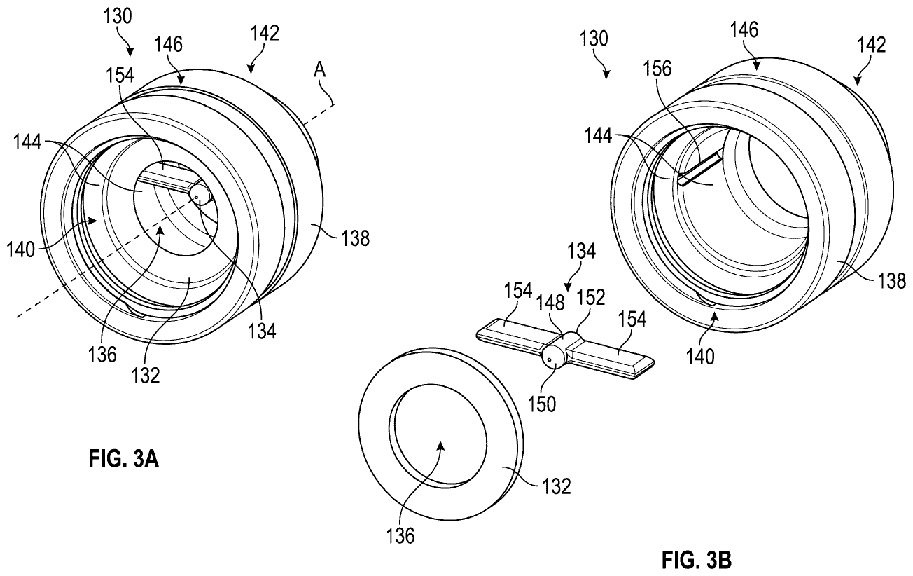

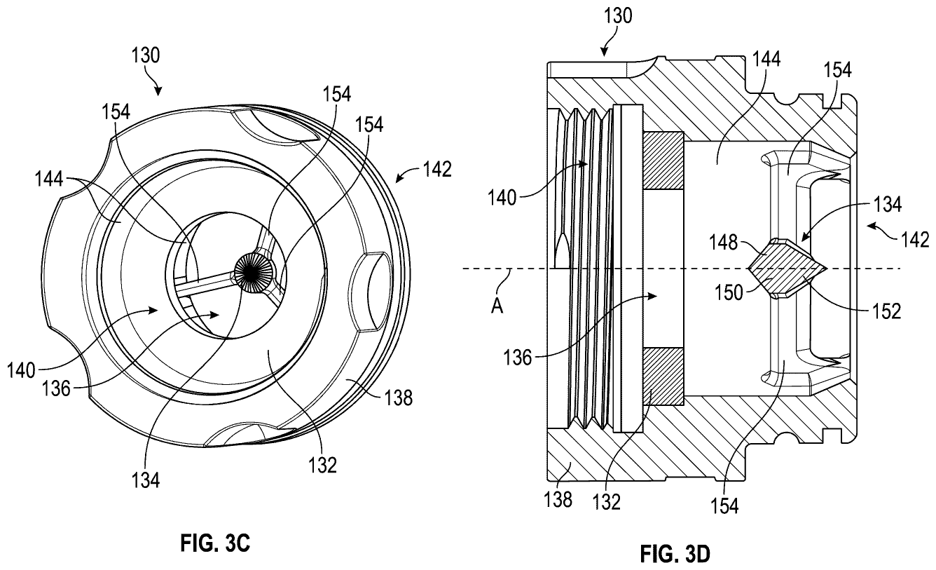

FIG. 3A, showing the flow path of fluid flowing through the backpressure booster.

FIG. 5 is a schematic cross-sectional view of another backpressure booster, showing the flow path of fluid flowing through the backpressure booster, according to some embodiments.

FIG. 6A is a side view of a hose and a nozzle assembly having a backpressure booster positioned between the hose and the shut-off valve assembly, according to some embodiments.

FIG. 6B is a cross-sectional view of the hose and nozzle assembly of FIG. 6A.

FIG. 7A is a side view of a hose and nozzle assembly having a backpressure booster positioned between the shut-off valve assembly and the nozzle, according to some embodiments.

FIG. 7B is a cross-sectional view of the hose and nozzle assembly of FIG. 7A.

FIG. 8A is a side view of a shut-off valve assembly having an integrated backpressure booster portion.

FIG. 8B is a cross-sectional view of the shut-off valve assembly of FIG. 8A.

FIG. 9A is a side view of a nozzle having an integrated backpressure booster portion.

FIG. 9B is a cross-sectional view of the nozzle of FIG. 9A.

### DETAILED DESCRIPTION

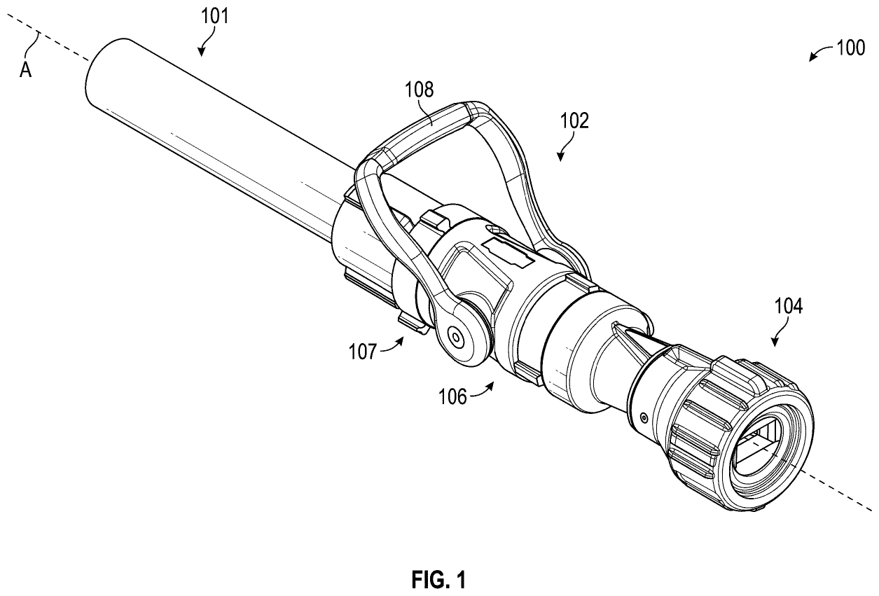

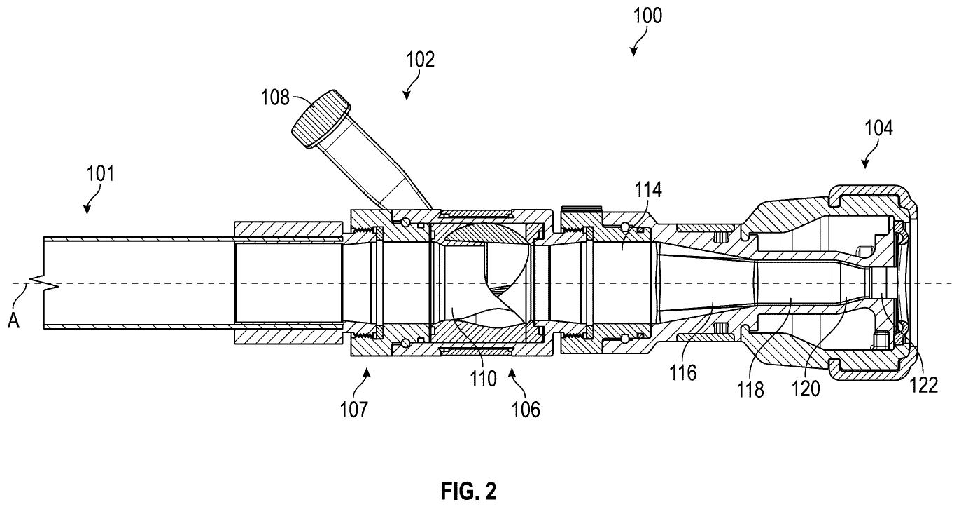

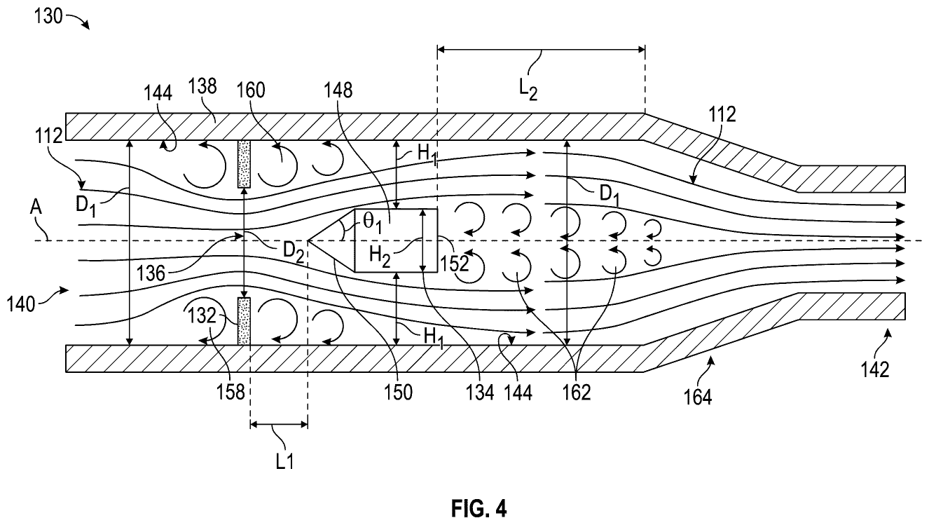

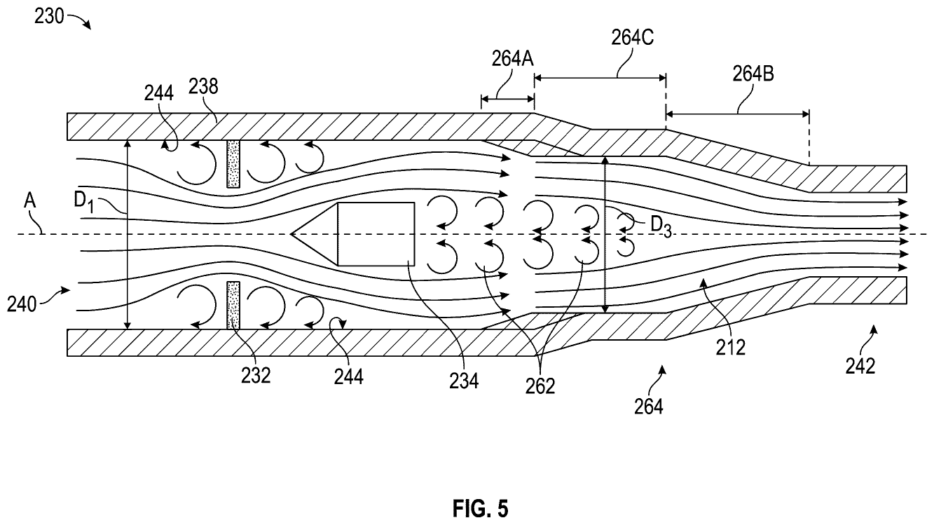

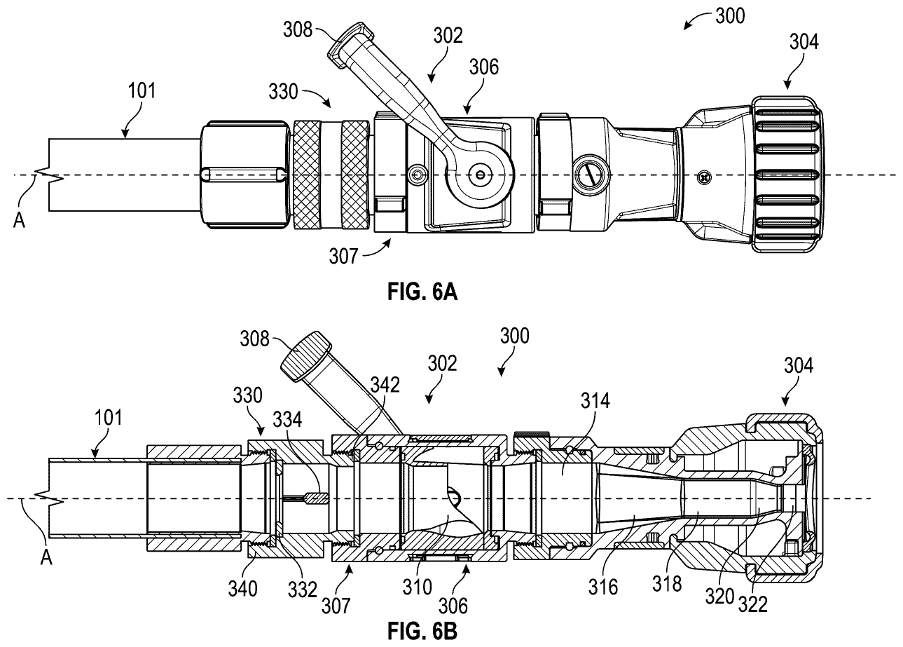

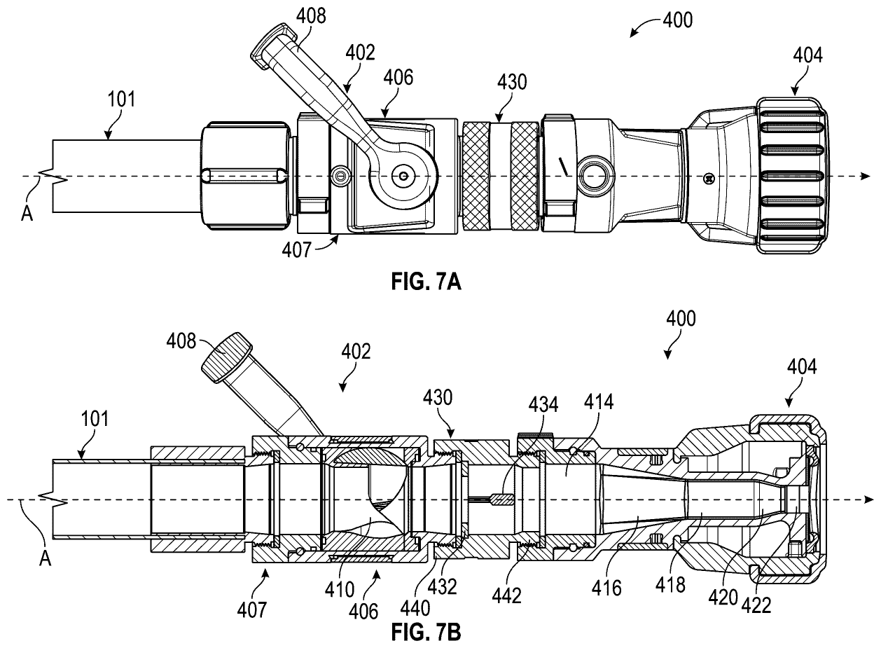

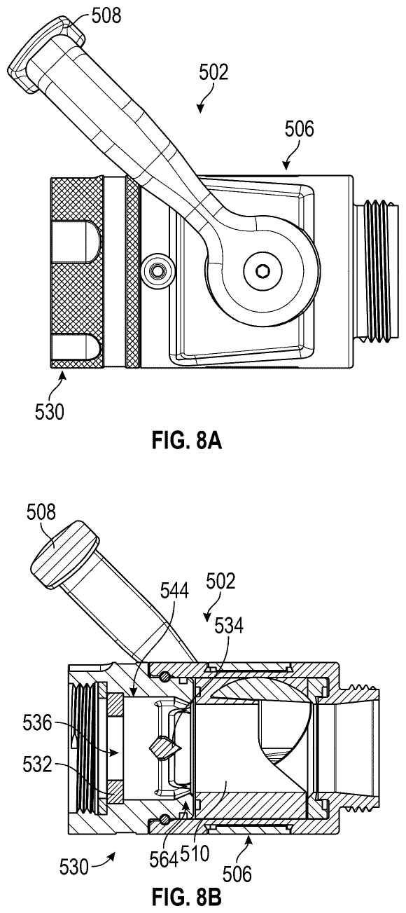

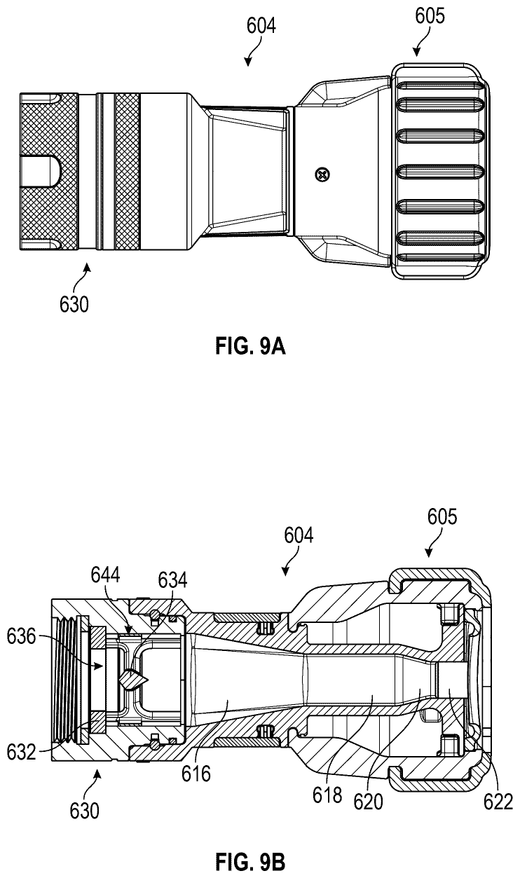

FIG. 1 is a perspective view of a nozzle assembly 100 attached to a hose 101 and FIG. 2 is a cross-sectional view of the nozzle assembly 100 and hose 101. The nozzle assembly 100 comprises a shut-off valve assembly 102 and a nozzle 104, where the shut-off valve assembly 102 is securely (and fluidly) coupled to the hose 101. The shut-off valve assembly 102 comprises a valve portion 106 and a hose coupling portion 107, where the valve portion 106 includes an actuator 108 and a valve 110 (FIG. 2) connected to the actuator 108. The shut-off valve assembly 102 and the nozzle 104 define an internal flow path through the nozzle assembly 100 for the fluid to follow. The hose coupling portion 107 securely couples the shut-off valve assembly 102 to the hose 101 (e.g., with threading) and, in some embodiments, can be rotationally coupled to the valve portion 106 such that the shut-off valve assembly 102 and nozzle 104 can freely rotate or swivel about a central axis A of a backpressure booster 130 (see FIGS. 3A-4). To facilitate the rotational movement of the shut-off valve assembly 102 relative to the hose 101, the nozzle assembly shut-off valve assembly 102 can include bearings and a sealing member (e.g., an O-ring) between the hose coupling portion 107 and the valve portion 106.

The hose 101 can be connected to a fluid source (not shown) that can provide fluid (e.g., water) to the hose 101 under pressure. The hose 101 is in fluid communication with the nozzle assembly 100 and is configured to provide the fluid to the nozzle assembly 100 (also under pressure). As the fluid passes into the nozzle assembly 100, it follows the flow path toward the shut-off valve assembly 102. In some embodiments, including the illustrated embodiment, the valve 110 comprises a ball valve. In other embodiments, however, the valve 110 comprises a different kind of valve, such as a partial ball valve or a needle valve. The valve 110 is operable to move between a fully-open position and a closed position. In the illustrated embodiment, the valve 110 is in the fully-open position. When the valve 110 is in the fully-open position, fluid can pass through the shut-off valve assembly 102 with minimal disruption to the flow path, without introducing turbulence to the fluid, and with minimal changes in pressure and/or flow rate. When the valve 110 is in the closed position, the valve 110 completely blocks the flow path and prevents the fluid from flowing through the valve portion 106 of the shut-off valve assembly 102. The valve 110 can also be operable in one or more additional positions between the fully-open position and the closed position. In these embodiments, the valve 110 partially blocks the flow path such that the fluid can still pass through the shut-off valve assembly 102 but the partially-closed valve 110 can affect one or more of the pressure, flow rate, and turbulence of the fluid.

The actuator 108 can be operably coupled to the valve 110 and can be used to move the shut-off valve assembly between the fully-open configuration (when the actuator is in a rearward position, as shown in FIGS. 1 and 2) and the closed configuration (when the actuator is in a forward position), which causes the valve 110 to rotate. The actuator can also be used to manipulate the position and orientation of the nozzle assembly 100 to allow for an operator of the nozzle assembly 100 to direct and control the fluid coming out of the nozzle 104.

With reference still to FIG. 2, the nozzle 104 has an inlet section 114, a converging section 116 positioned downstream of the inlet section 114 relative to the flow direction, a transition section 118 positioned downstream of the converging section 116, a hybrid section 120 positioned downstream of the transition section 118, and a flow modulation section 122 positioned downstream of the hybrid section 120. In the hybrid section 120, the nozzle 104 can have opposing top and bottom walls that converge in the downstream direction, and two opposed side walls (only one of which is visible in FIG. 2) that diverge in the downstream direction. The nozzle 104 can include control arms (not shown) positioned in the flow modulation section 122 that are manually operable/movable toward or away from a central axis A of the backpressure booster 130 to control the spray pattern of fluid exiting the nozzle 104. Other details relating to the nozzle 104 and other aspects can be found in U.S. patent application Ser. No. 17/828,087, filed on May 31, 2022 and entitled Smooth Bore Nozzle, and U.S. patent application Ser. No. 18/390,658, filed on Dec. 20, 2023 and entitled Adjustable Nozzle, the entire contents of both of which are hereby expressly incorporated by reference herein.

In the illustrated embodiment, the nozzle 104 includes the inlet section 114, the converging section 116, the transition section 118, the hybrid section 120, the flow modulation section 122, and the control arms (not shown) as described above. In other embodiments, however, the nozzle 104 may not include one or more of the inlet section 114, the converging section 116, the transition section 118, the hybrid section 120, the flow modulation section 122 and/or the control arms. The nozzle 104 can also include other or additional sections, component or the like beyond those shown and described herein.

In some embodiments, the fluid source upstream of the hose 101 can be a firefighting water supply, such as a fire hydrant or fire pumper, and can be configured to provide the fluid to the hose 101 at pressures between about 100 psi and 300 psi. In other embodiments, however, the fluid source can be configured to provide fluid to the hose 101 at a different pressure. For example, in some embodiments, the fluid source can provide fluid to the hose 101 at a pressure of about 50 psi, about 75 psi, about 100 psi, about 150 psi, about 200 psi, about 300 psi, about 400 psi, greater than about 25 psi, greater than about 100 psi, greater than about 400 psi, less than about 400 psi, or a value in a range between any of the foregoing values. As used herein, disclosed pressures refer to total pressure, which includes both static and dynamic pressures of the fluid. The inner diameter of the hose 101 for such firefighting applications can be, for example, about 0.75 inches, about 1 inch, about 1.5 inches, about 1.75 inches, about 2 inches, about 2.25 inches, about 2.5 inches, about 2.75 inches, about 3 inches, or a value in a range between any of the foregoing values. In some embodiments, the fluid source can output a high volume of water but at a pressure that is too low for firefighting applications and/or that does not maintain consistently high pressures. In these embodiments, the fluid source can include a pump configured to receive water from a fire hydrant or other water source and that is configured to increase and/or maintain the fluid pressure and to provide the pressurized fluid to the hose 101. In these embodiments, the pump can be fluidly coupled to the fire hydrant with a supply hose while the hose 101 to which the nozzle attaches can be an attack hose. Supply hoses are generally larger than attack hoses and can handle larger quantities of water than attack hoses but may not be able withstand as much pressure or as many bends as attack hoses. Accordingly, in embodiments where the hose 101 is an attack hose, the diameter of the hose 101 can be less than 5 inches. Typically attack hoses have inner diameters between about 0.75 inches and 3 inches, with most fire departments using 1.5 inch, 1.75 inch, and/or 2.5 inch hoses.

The fluid source can discharge high volumes of water, such as between about 150 and about 265 gallons per minute in some embodiments. In other embodiments, however, the fluid source can be configured to discharge different volumes of water. For example, in some embodiments, the fluid source can discharge about 15 gallons per minute (gpm), about 20 gpm, about 50 gpm, about 75 gpm, about 100 gpm, about 125 gpm, about 150 gpm,, about 175 gpm, about 200 gpm, about 225 gpm, about 250 gpm, about 265 gpm, about 275 gpm, about 300 gpm, more than 300 gpm, or a value in a range between any of the foregoing values. For example, 1.0 inch hoses for firefighting applications, such as forestry, can discharge about 15-20 gpm; 1.5 inch hoses for firefighting applications can discharge about 100-185 gpm; and 2.5 inch hoses for firefighting applications can discharge about 185-300 gpm. Discharging fluids in such high volumes can impart a significant reaction force to the hose operator, such that the hose operator can experience a reactive force between about 60 lbs. and about 100 lbs. in some embodiments.

In some embodiments, it can be desired to have a relatively high fluid pressure in the hose (e.g. a fluid pressure above 75 psi), as such high pressure can increase the stiffness of the hose, thereby reducing kinking and/or hose whip. In particular, a hose operator may typically grip the hose at a position upstream of the nozzle, and sufficient stiffness of the hose enables the operator to grip the hose at the upstream position. However, the pressure of the fluid in the hose typically decreases along the length of the hose (due to, for example, pressure losses caused by friction between the fluid and the inside wall of the hose, the presence of kinks, bends, or twists in the hose, elevation changes), which can result in the hose pressure at the nozzle assembly being significantly reduced compared to the pressure output by the fluid source. Having a high fluid pressure at the nozzle can provide a relatively high reaction force that must be countered by the hose operator, leading to operator fatigue. Additionally, relatively higher fluid pressures can also create safety issues if the operator loses control of the hose. Higher pressures can also cause greater wear and tear on the hose, nozzle and other components in the fluid flow path. On the other hand, providing a relatively low pressure in the hose (e.g. about 50 psi) can lead to increased kinking in the hose, and/or an unstable hose end that is more difficult to handle and aim.

Accordingly, there is a need for a nozzle assembly that increases the pressure and therefore stiffness in the hose near the nozzle assembly without imparting excessive reaction forces to the nozzle handler, and without creating excessive turbulence that can adversely affect the stream exiting the nozzle.

Nozzle reaction is the force exerted on the operator handling the hose and nozzle assembly and is directly proportional to the flow-rate of fluid (e.g., water) exiting the nozzle assembly. The flow-rate of the fluid exiting the nozzle assembly depends on the opening size and pressure at the outlet of the nozzle. For a given nozzle exit opening size and pressure, the flow-rate and pressure are both constant. For a conventional smoothbore nozzle assembly, the pressure loss of the fluid as it flows through the nozzle assembly is minimal and the pressure at the inlet of the nozzle assembly is equal to the pressure at outlet of the nozzle assembly. In other words, in a conventional firefighting nozzle assembly, there is very little pressure drop from the outlet of the hose to the outlet of the smoothbore nozzle assembly, which means that Pₕₒₛₑ=P_{nozzle}.

In some embodiments, it can be desirable for Phose to be greater than 75 psi to ensure a higher maneuverability of the hose and reduce occurrence of kinking. However, it can also be desirable for Pnozzle to be less than 50 psi so as to reduce the nozzle reaction experienced by the nozzle assembly operator. One way of accomplishing this advantageous pressure profile is for the nozzle assembly to create a pressure drop across its length. Conventional pressure regulating devices include regulating valves and orifice plates. However, pressure reducing valves are not suitable for firefighting applications because of their heavy weight and orifice plates generate a significant turbulence in the fluid and require long pipe sections to reduce the turbulence. Accordingly, there is a need for a nozzle assembly that can create a pressure drop within the nozzle assembly without adding significant weight or length and without significant increases in turbulence.

### Backpressure Booster

FIG. 3A is a perspective view of a backpressure booster 130 and FIG. 3B is an exploded perspective view of the backpressure booster 130. The backpressure booster 130 can be integrated with a nozzle assembly similar to the nozzle assembly 100 of FIGS. 1 and 2, as shown and described below with respect to FIGS. 6A-7B below.

The back pressure booster 130 includes a housing 138, a flow restrictor 132, and a flow conditioner 134 positioned downstream of the flow restrictor 132. The housing 138 has an inlet 140 at a rear or back end, an outlet 142 at a front end, an inner surface 144, and an outer surface 146, where a flow path 112 (see FIG. 4) of the fluid enters the backpressure booster 130 through the inlet 140 and leaves the backpressure booster 130 through the outlet 142. The flow restrictor 132 and the flow conditioner 134 are positioned within the housing 138 such that flow restrictor 132 is positioned proximate to the inlet 140 while the flow conditioner 142 is positioned downstream from the flow restrictor 132 and proximate to the outlet 142. The flow restrictor 132 can take the form of a relatively thin orifice plate, which is annular in the illustrated embodiment, having a restricted orifice/opening 136 through which the flow path 112 passes. The flow restrictor 132 provides an area of restricted flow relative to the upstream hose 101, and thus provides increased pressure in the flow path 112 at locations upstream of the flow restrictor 132 (e.g., creates/increases backpressure). However, the flow restrictor 132 can introduce downstream instabilities, turbulence, and/or eddies (collectively referred to as “eddies” herein) into the flow path 112. The flow conditioner 134 can be configured to divert the flow path away from the central axis A and towards the inner surface 144 of the housing 138 to “squeeze out” and reduce or eliminate the downstream eddies, leading to a more stable flow.

In some embodiments, including the embodiment shown in FIGS. 3A and 3B, the housing 138 and the inner surface 144 are generally cylindrical and the opening 136 of the flow restrictor 132 is generally cylindrical. In these embodiments, the diameter of the inner surface 144 can be greater than the diameter of the opening 136. More generally, the inner surface 144 defines a greater cross-sectional area transverse to the flow path 112 than the opening 136. With this arrangement, as the fluid flows from the inlet 140 through the flow restrictor 132, the cross-sectional area of the flow path 112 decreases, which increases the pressure in the fluid upstream of the flow restrictor 132.

In the illustrated embodiment, the inner surface 144 is cylindrical and the opening 136 is circular. In other embodiments, however, the inner surface 144 may not be cylindrical. For example, in some embodiments, the inner surface 144 can converge and/or diverge near the flow restrictor 132. In these embodiments, the diameter or (cross-sectional area) of the inner surface 144 can be taken as the diameter (or cross-sectional area) of the inner surface 144 at the midpoint (in the downstream direction) of the converging or diverging portion of the inner surface 144. In some embodiments, one or both of the inner surface 144 and the opening 136 can have a non-circular shape. For example, in some embodiments, one or both of the inner surface 144 and the opening 136 can be an irregular shape such as elliptical, oval or the like, or a geometric shape such as octagonal, hexagonal, etc.

The flow conditioner 134 is positioned downstream from the flow restrictor 132 and has a body 148 having an upstream portion 150 and a downstream portion 152. The body 148 is connected to the inner surface 144 of the housing 138 by way of arms 154, which extend from the inner surface 144 to the body 148 of the flow conditioner 134 to position the flow conditioner 134 at the desired location in the flow path 112. The housing 138 can include grooves 156 formed in the inner surface 144 that are sized and positioned to receive the arms 154 therein to retain the flow conditioner 134 in place. In other embodiments, the arms 154 are held in place using a different attachment means. For example, in some embodiments, the flow conditioner 134 and arms 154 can be formed as an integral part of the housing 138. In some embodiment, the arms 154 can have a tapered leading edge and/or a tapered trailing edge to reduce any turbulence or eddies introduced into the flow path 112 by the arms 154. In some embodiments, at least a portion of the upstream portion 150 of the flow conditioner 134 can be positioned upstream of the arms 154, which can help to ensure the flow conditioner 134 provides the desired effects upon fluid flow, reducing any interference downstream turbulence provided by the arms 154. In some embodiments, the entire upstream portion 150 of the flow conditioner 134 can be positioned upstream of the arms 154.

In some embodiments, including the illustrated embodiment, the inlet 140 and the outlet 142 can have internal (as shown) or external threading (or some other attachment means) configured to releasably attach to threading (or other attachment means) on a portion of the nozzle assembly (e.g., nozzle assembly 100) or the hose to fluidly and releasably attach the backpressure booster 130 to other parts of the nozzle assembly or the hose. As described below, the backpressure booster 130 can be positioned at various locations along a nozzle assembly.

In some embodiments, including the illustrated embodiment, the flow conditioner 134 is attached to the housing 138 with two arms 154 that are located about 180° apart. In other embodiments, however, the flow conditioner 134 is attached to the housing 138 with a different number of arms 154 and/or the arms 154 are positioned at other angles. For example, FIG. 3C is a perspective view of an alternative version of the backpressure booster 130 in which the flow conditioner 3C is attached to the housing 138 with three arms 154 and FIG. 3D is a cross-sectional view of the alternative version of the backpressure booster 130. The three arms 154 can be spaced equidistantly around the flow conditioner 134 such that the three arms 154 are located about 120° apart. In some embodiments, however, the backpressure booster 130 can include more than three arms 154 and/or the arms 154 are unevenly spaced apart.

FIG. 4 is a schematic cross section of the backpressure booster 130 showing the flow path 112 through the backpressure booster 130. The fluid enters the backpressure booster 130 through the inlet 140 and flows towards the flow restrictor 132. The cross-sectional area of the opening 136 of the flow restrictor 132 is less than the cross-sectional area of the inner surface 144. At the inlet 140, the inner surface 144 of the housing 138 has a diameter (or effective diameter) D₁ and the opening 136 has a diameter (or effective diameter) D₂ that is less than D₁. In some embodiments, D₁ is between about 1.0 inch and 3.5 inches (or between about 1.5 inches and 2.5 inches), with common examples for firefighting applications of 1 inch, 1.5 inches, 2.5 inches, and 3.5 inches. In some embodiments, the diameter D₂ is between about 50% and about 75% of the diameter D₁. In other embodiments, the diameter D₂ can be between about 25% and about 90% of the diameter D₁, between about 25% and about 50% of the diameter D₁, between about 50% and about 90% of the diameter D₁, between about 25% and about 75% of the diameter D₁, between about 75% and about 90% of the diameter D₁ or a value in a range between any of the foregoing values. In some embodiments, the relative sizes of the opening 136 and the inner surface 144 can be discussed with reference to the cross-sectional areas of the opening 136 and the inner surface 144. For example, in some embodiments, the opening 136 can have a cross-sectional area that is between about 25% and about 55% of the cross-sectional area of the inner surface 144 of the housing 138. In other embodiments, the cross-sectional area of the opening 136 can be about between about 5% and about 80% of the cross-sectional area of the inner surface 144, between about 5% and about 25% of the cross-sectional area of the inner surface 144, between about 25% and about 80% of the cross-sectional area of the inner surface 144, between about 5% and about 55% of the cross-sectional area of the inner surface 144, between about 55% and about 80% of the cross-sectional area of the inner surface 144, or a value in a range between any of the foregoing values.

As the fluid flows towards the flow restrictor 132, the reduced size of the opening 136 relative to the inner surface 144 results in the flow restrictor 132 partially obstructing the fluid and increasing the backpressure of the fluid upstream of the flow restrictor 132 (e.g., the hose pressure). However, the flow restrictor 132 can introduce instabilities, turbulence and/or eddies (collectively termed “eddies” herein) into the flow path 112, including upstream eddies 158 located upstream of the flow restrictor 132, and downstream eddies 160 located downstream of the flow restrictor 132. The downstream, flow restrictor-induced eddies 160 are typically located at the radially outer portions of the flow path 112. The flow conditioner 134 is shown to be positioned directly downstream from the opening 136 such that, as the fluid passes through the opening 136, it encounters the flow conditioner 134. The flow conditioner 134 is positioned and shaped to direct a central portion of the fluid that flowed through the opening 136, which is typically more stable/uniform than peripheral portions of the fluid, radially outwardly toward the peripheral portions where the eddies 160 form. In this manner the outwardly-directed, stable flow tends to “squeeze out,” and reduce or eliminate, the eddies 160 (as shown by the reducing size of the eddies 160 of FIG. 4 in the downstream direction), leading to a more stable flow.

In some embodiments, the body 148 of the flow conditioner 134 can be sufficiently spaced away from the inner surface 144, in the radial direction, to allow fluid to flow around the body 148 of the flow conditioner 134 and to avoid introducing restrictions within which solid particles can become stuck. In some embodiments, the body 148 of the flow conditioner 134 can be spaced away from the inner surface 144 of the housing 138 in a radial direction by dimension H₁. In some embodiments, the dimension H₁ is about 35% of the diameter D₁ of the inner surface 144 (or an average diameter of the inner surface 144, in areas where the body 148 is located if the inner surface 144 has a variable diameter). In other embodiments, however, the dimension H₁ can be a different size relative to the diameter D₁. For example, in some embodiments, the dimension H₁ can be about 25% of the diameter D₁, about 30% of the diameter D₁, about 35% of the diameter D₁, about 40% of the diameter D₁, about 45% of the diameter D₁, or a value in a range between by any of the foregoing values. Additionally, in some embodiments, the arms (e.g., arms 154 shown and described above in connection with FIGS. 3A-3D) of the flow conditioner 134 can be spaced apart from each other such that the gaps between adjacent arms are sufficiently large that solid particles (e.g., solid particles having a diameter of about 0.5 inch or smaller) cannot get stuck between the adjacent arms. In some embodiments, the spacing is such that solid particles of ⅝ inch or smaller can pass between adjacent arms. In some embodiments, the spacing is such that solid particles of 1 inch or smaller can pass between adjacent arms.

In some embodiments, the flow conditioner 134 is sized such that a dimension (e.g., diameter or effective diameter) H₂ of the body 148 of the flow conditioner 134 is about 25% of the diameter (or effective diameter) D₁ of the inner surface 144 of the housing 138. In other embodiments, however, the dimension H₂ can be a different size relative to the diameter D₁. For example, in some embodiments, the dimension H₂ can be about 10% of the diameter D₁, about 15% of the diameter D₁, about 20% of the diameter D₁, about 25% of the diameter D₁, about 30% of the diameter D₁, about 35% of the diameter D₁, about 40% of the diameter D₁, about 45% of the diameter D₁, or a value in a range between any of the foregoing values. In some embodiments, the flow conditioner 134 is sized such that dimension H₂ is about the same size as the diameter D₂ of the opening 136. For example, in some embodiments, the dimension H₂ is about 70% of the diameter D₂, about 80% of the diameter D₂, about 90% of the diameter D₂, about 100% of the diameter D₂, about 110% of the diameter D₂, about 120% of the diameter D₂, about 130% of the diameter D₂, or a value in a range between any of the foregoing values. In some embodiments, the flow conditioner 134 is sized such that a maximum cross-sectional area of the body 148 is between about 25% and about 55% of the cross-sectional area (or average cross-sectional area) of the inner surface 144 in the area where the body 148 of the flow conditioner 134 is located. In other embodiments, however, the flow conditioner 134 can be sized such the maximum cross-sectional area of the body 148 is a different size relative to the cross-sectional area of the inner surface 144. For example, in some embodiments, the flow conditioner 134 is sized such that a maximum cross-sectional area of the body 148 is about 25% of the cross-sectional area of the inner surface 144, about 35% of the cross-sectional area of the inner surface 144, about 45% of the cross-sectional area of the inner surface 144, about 55% of the cross-sectional area of the inner surface 144, or a value in a range between any of the foregoing values. In general, the flow conditioner 134 can be sized such that a cross-sectional area of the body 148 is sufficiently large that it pushes the flow path radially outward but is not so large as to introduce significant restrictions in the flow path 112.

The upstream portion 150 of the flow condition 134 can be shaped to direct the fluid outward towards the inner surface 144 of the housing 138 to facilitate the “squeezing out” of the eddies 160. In some embodiments, including the illustrated embodiment, the upstream portion 150 is conically-shaped and has a surface that forms an angle θ₁ with the central axis A of the backpressure booster 130. In some embodiments, the angle θ₁ is about 45°. In other embodiments, however, the angle θ₁ can be a different angle. For example, in some embodiments, the angle θ₁ can be between about 30°, about 40°, about 45°, about 50°, about 60°, about 70°, about 75°, or a value in a range between any of the foregoing values. In other embodiments, however, the upstream portion 150 can have a different shape. For example, in some embodiments, the upstream portion 150 can have a curved surface relative to the central axis A.

In some embodiments, including the illustrated embodiment, the downstream portion 152 of the flow conditioner 134 can be cylindrical. With this arrangement, the diameter of the downstream portion 152 can substantially match the diameter of the base of the upstream portion 150 to provide a smooth transition therebetween. In other embodiments, however, the downstream portion 152 can have a different shape, such as a conical shape that tapers radially inward in the downstream direction. For example, in the embodiment illustrated in FIG. 3D, the downstream portion 152 has a conical shape. In these embodiments, the surface of the conical downstream portion 152 can form an angle with the central axis A of the backpressure booster 130 that is less than the angle θ₁. In other embodiments, however, the surface of the conical downstream portion 152 can form an angle with the central axis A that is the same as the angle θ₁. In still other embodiments, the angle that the surface of the conical downstream portion 152 forms with the central axis A is larger than angle θ₁.

Returning to FIG. 4, the flow conditioner 134 is positioned downstream of the flow restrictor 132 and is illustrated as entirely spaced away from and not directly coupled to the flow restrictor 132. For example, the flow conditioner 134 and the flow restrictor 132 can be made of separate or separable components, each of which is attached or attachable to the housing 138. In some embodiments, the flow conditioner 134 can be positioned sufficiently downstream from the flow restrictor 132 to avoid significant restrictions of the fluid as it flows through the flow restrictor 132 and around the flow conditioner 134. In some embodiments, the flow conditioner 134 is spaced away from the flow restrictor 132 in the downstream direction by dimension L₁. where L₁ is between about 20% and about 35% of the diameter D₁ of the inner surface 144. With this arrangement, the fluid can flow around the flow conditioner 134 without significantly restricting the flow of the fluid or allowing solid particles from getting stuck between the flow restrictor 132 and the flow conditioner 134. Additionally, spacing the flow conditioner 134 downstream from the flow restrictor 132 by the dimension L₁ can enable some of the flow restrictor-induced eddies 160 to naturally abate before being conditioned by the flow conditioner 134.

It can be advantageous to provide the flow conditioner 134, flow restrictor 132, and housing 138 as separate and assembled components, as shown. In addition to advantages in manufacturing, such separate provision of these parts can allow for modular replacement of one or both of the flow conditioner 134 and the flow restrictor 132, for example, for different applications or source pressures, or for redesigned components affecting the flow characteristics. In other embodiments, however, two or more of these components can be formed (e.g., molded or cast) as a single component.

The flow conditioner 134 itself can introduce eddies 162 downstream of the flow conditioner 134, where such eddies 162 are typically located at the center of the flow path 112, away from the radially outer portions of the flow path 112. However, at portions downstream of the flow conditioner 134, the radially-outer portions of the flow can be relatively stable/uniform due to the inner surface 144 directing the fluid downstream. Thus, the backpressure booster 130 can include a converging section 164, located sufficiently downstream of the flow conditioner 134, that effectively directs the more stable flow, located at the radially outer positions, in the radially inner direction. As the more stable fluid is squeezed radially inwards, the fluid essentially “squeezes out” the eddies 162, leading to a more stable/uniform overall flow (as shown by the reducing size of the eddies 162 of FIG. 4 in the downstream direction) at the outlet 142 of the backpressure booster 130. The effective diameter of the flow path 112 decreases in the flow direction along the length of the converging section 164 such that, in some embodiments, the effective diameter of the flow path 112 at the outlet 142 is smaller than D₁ by 40%. In other embodiments, however, the effective diameter of the flow path 112 at the outlet 142 can be smaller than D₁ by a different amount. For example, in some embodiments, the effective diameter of the flow path 112 at the outlet 142 is smaller than D₁ by about 15%, by about 25%, by about 35%, by about 45%, by about 50%, by about 55%, by about 65%, by about 75%, or by a value in a range between any of the foregoing values. In some embodiments, the cross-sectional area of the flow path 112 at the outlet 142 can be smaller than the cross-sectional area of the inner surface 144 by about 25%, by about 35%, by about 45%, by about 50%, by about 55%, by about 65%, by about 75%, by about 85%, by about 95%, or by a value in a range between any of the foregoing values.

The converging section 164 can be positioned downstream from the flow conditioner 134 by a dimension L₂. In some embodiments, the converging section 164 is relatively close to the flow conditioner 134. For example, in some embodiments, the dimension L₂ is about 25% of D₁. This arrangement initiates convergence of the flow relatively quickly upon passing the flow conditioner 134, thus enabling streamlines to straighten more quickly as they approach the outlet 142. In other embodiments, however, the converging section 164 can be a different distance from the flow conditioner 134. For example, in some embodiments, the dimension L₂ can be about 10% of D₁, about 20% of D₁, about 30% of D₁, about 40% of D₁, about 50% of D₁, about 60% of D₁, about 70% of D₁, about 75% of D₁, about 80% of D₁, about 90% of D₁, about 100% of D₁, about 120% of D₁, about 150% of D₁, about 200% of D₁, or a value in a range between any of the foregoing values. In some embodiments, the distance from the flow conditioner 134 to the start of the converging section 164 can depend on the size and/or shape of the flow conditioner 134. For example, in some embodiments, the distance from the flow conditioner 134 to the start of the converging section 164 can depend on the angle θ₁ that the surface of the upstream portion 150 of the flow conditioner 130 forms with central axis A of the backpressure booster 130. In the illustrated embodiment, the convergent section 164 decreases in size at a consistent rate. In other embodiments, however, the convergent section 164 can decrease in size at a variable rate along the length of the converging section 164.

After flowing through the convergent section 164, the fluid flows into the outlet 142 of the backpressure booster 130 and then out of the backpressure booster 130. At this point the fluid flow is relatively smooth and uniform as it leaves the backpressure booster 130. Accordingly, in addition to increasing the backpressure in the hose, the backpressure booster 130 can provide a relatively smooth, laminar flow (which reduces eddies) in a relatively short distance. For example, in some embodiments, the backpressure booster 130 has an axial length that is about the same as the effective diameter D₁ of the inner surface 144 (and/or average diameter of the inner surface 144, in embodiments where inner surface 144 has a variable diameter). In other embodiments, however, the backpressure booster 130 can have an axial length that is shorter or longer than the effective diameter D₁ of the inner surface 144. For example, in some embodiments, the axial length of the backpressure booster 130 is about 80% of D₁, about 90% of D₁, about 100% of D₁, about 150% of D₁, about 200% of D₁, about 300% of D₁, about 400% of D₁, or a value in a range between any of the foregoing values.

The flow restrictor 132 and the flow conditioner 134 can be sized, shaped, and positioned within the housing 138 to avoid introducing restrictions within the fluid path 112 to enable fluid to freely flow through the flow path 112 and to ensure that any solid particles or components do not become stuck within the backpressure booster 130. Thus, in some embodiments, the backpressure booster 130 lacks restrictions in the flow path 112 having a cross-sectional area of less than 0.030 square inches.

In the embodiment of FIG. 4, the backpressure booster 130 includes a convergent section 164 having a single stage. In other embodiments, the backpressure booster can include a multi-stage convergent section. FIG. 5 is a schematic cross section of a backpressure booster 230 having a multi-stage convergent section 264. Except for the inclusion of the multi-stage convergent section 264, the backpressure booster 230 can be otherwise identical to the backpressure booster 130, with reference numbers incremented by 100.

The convergent section 264 includes first and second converging stages 264A, 264B and a straight section 264C between the first and second stages 264A, 264B. As the flow path 212 flows around the flow conditioner 234, of which the body 248 is shown, the first stage 264A directs the flow radially inwards, to initiate the “squeezing out” process of the eddies 262. The effective diameter of the flow path 212 decreases along the length of the first stage 264A of the converging section 264 until reaching the straight section 264C, which has a diameter (or effective diameter) D₃ that is less than the diameter D₁. In some embodiments, the diameter D₃ is about 90% of D₁. In other embodiments, however, the diameter D₃ has a different size relative to D₁. For example, in some embodiments, D₃ is about 80% of D₁, about 85% of D₁, about 90% of D₁, about 95% of D₁, or a value in a range between any of the foregoing values. As the fluid moves through the straight section 264C, the flow path 212 straightens out until it reaches the second converging stage 264B of the convergent section 264. Here, the effective diameter of the flow path 212 decreases again along the length of the second stage 264B until it reaches the outlet 242, which is smaller than DI by a value 15%, by 25%, by 35%, by 45%, by 50%, by 55%, by 65%, by 75%, or by a value in a range between any of the foregoing values. Forming the convergent section 264 from multiple converging stages 264A, 264B can enable quicker streamlining of the flow path 212, which can lead to a reduction in length of the backpressure booster 230 for a given level of laminarity, which in turn reduces the length and weight of the overall nozzle assembly.

In some embodiments, the first and second converging stages 264A, 264B can have the same dimensions. For example, in some embodiments, the length (in the axial direction) of the first converging stage 264A and the slope of the inner surface 244 within the first stage 264A can be about the same as the length of the second converging stage 264B and the slope of the inner surface 244 within the second stage 264B. In other embodiments, the length and/or slope of the first converging stage 264A can be different than that of the second converging stage 264B. In general, the first and second stages 264A, 264B can have any suitable length and slope. Similarly, in some embodiments, the straight section 264C can have a length that is about the same length as the length of one or both of the first and second stages 264A, 264B. In other embodiments, however, the straight section 264C can have a length that is different than the length of one or both of the first and second stages 264A, 264B.

### Nozzle Assemblies Having a Backpressure Booster Incorporated Therein

As previously described, discharging high volumes of water at high pressures with a conventional nozzle assembly can impart a significant reaction force on the hose operator that must be countered by the hose operator and that can lead to fatigue and other safety issues. However, reducing hose pressure and/or flow rate to avoid or reduce operator fatigue and hose-related injuries can result in hose kinking or an unstable hose and present other problems to a firefighter. To ensure that high hose pressures and flow rates can be utilized while also avoiding or reducing the reaction forces imparted onto the hose operators, a backpressure booster as described above can be incorporated into nozzle assemblies.

FIG. 6A is a side view of a nozzle assembly 300 attached to the hose 101 and FIG. 6B is a cross-sectional view of the nozzle assembly 300 and hose 101, where the nozzle assembly 300 includes a backpressure booster 330 releasably (and fluidly) coupled between the hose 101 and the shut-off valve assembly 302. Except for the inclusion of the backpressure booster 330, the nozzle assembly 300 can be otherwise similar or identical to the nozzle assembly 100 shown and described above in connection with FIGS. 1 and 2, with reference numbers incremented by 200. Similarly, the backpressure booster 330 can be similar or identical to backpressure boosters 130, 230 shown and described above in connection with FIGS. 3A-5, with reference numbers incremented by 200 and 100, respectively.

The backpressure booster 330 is incorporated into the nozzle assembly 300 upstream of the shut-off valve assembly 302. The inlet 340 and the outlet 342 of the backpressure booster 330 can each include threading, where the threading of the inlet 340 is releasably attached to threading at the downstream end of the hose 101 (which can be sized as described above for firefighting applications, such as standard 1″, 1.5″, 2.5″, and 3.5″ fire hoses) and the threading of the outlet 342 is releasably attached to hose coupling section 307 at the upstream end of the shut-off valve assembly 302. In this embodiment, the fluid passes from the hose 101 into the backpressure booster 330 (via the inlet 340). The fluid passes through the flow restrictor 332 and then around the flow conditioner 334 before exiting the backpressure booster 330 (via the outlet 342) and passing into the shut-off valve assembly 302. The fluid then continues through the valve portion 306 of the shut-off valve assembly 302 (when a shut-off valve 310 is in an open configuration) and the nozzle 304 before exiting the nozzle assembly 300 via the nozzle 304. Positioning the backpressure booster 330 upstream of the shut-off valve assembly 302 can be useful in spacing the backpressure booster 330 further away upstream from the nozzle 304 because it enables flow exiting the backpressure booster 330 additional time/distance to stabilize after exiting the backpressure booster 330, presenting a relatively laminar flow to the nozzle 304.

Incorporating the backpressure booster 330 into the nozzle assembly 300 can increase the pressure within the hose 101 near the nozzle assembly 300 (which may be referred to as the hose pressure or Phose), which can increase the stiffness of the hose 101 at the downstream end (i.c., the end of the hose 101 that attaches to the nozzle assembly 300) of the hose 101, thereby making it easier for a hose operator to grab and control the hose 101, and reducing kinks that can interfere with the flow. For example, in some embodiments, the presence of the backpressure booster 330 can result in the hose pressure being greater than about 75 psi. In other embodiments, however, the hose pressure can be a different value. For example, in some embodiments, the total hose pressure can be between about 30 psi and about 200 psi, such as about 50 psi, about 75 psi, about 100 psi, about 125 psi, about 150 psi, about 200 psi, or a value in a range between any of the foregoing values. In some embodiments, incorporating the backpressure booster 330 into the nozzle assembly 300 can result in the hose pressure being about 50% higher than the hose pressure would be if the nozzle assembly did not include the backpressure booster 330. In other embodiments, backpressure booster 330 can increase the hose pressure by a different amount. For example, in some embodiments, the backpressure booster 330 can increase the hose pressure by between about 20% and about 80%, between about 20% and about 50%, between about 50% and about 80%, between about 40% and about 60%, or a value in a range between any of the foregoing values. In pressure difference terms, the presence of the backpressure booster 230 can result in the hose pressure being between about 15 psi and 45 psi, such as between about 20 psi and about 40 psi, greater than it would be if the nozzle assembly did not include the backpressure booster 330.

Incorporating the backpressure booster 330 into the nozzle assembly 300 can also cause a pressure drop within the nozzle assembly such that the pressure of the fluid exiting the nozzle (which can be referred to as the nozzle pressure or Pnozzle) is less than the hose pressure. For example, in some embodiments, the nozzle pressure can be lower than the hose pressure, and can be between about 30 psi and 150 psi, such as about 50 psi, about 45 psi, about 40 psi, about 35 psi, about 30 psi, or a value in a range between any of the foregoing values. In some embodiments, the pressure drop within the nozzle assembly due to the presence of the backpressure booster 330 can result in the nozzle pressure being between about 20% and about 70% of the hose pressure. In other embodiments, however, the nozzle pressure can be a different percentage of the nozzle pressure. For example, in some embodiments, the nozzle pressure can be about 70% of the hose pressure, about 60% of the hose pressure, about 50% of the hose pressure, about 40% of the hose pressure, about 30% of the hose pressure, about 20% of the hose pressure, or a value in a range between any of the foregoing values. In terms of pressure difference, the presence of the backpressure booster 330 can cause a pressure drop within the nozzle assembly 300 from the hose 101 to the nozzle 304 that is between about 15 psi and about 45 psi, such as between about 20 psi and about 40 psi. In other embodiments, however, the pressure drop can be a different value. For example, in some embodiments, the pressure drop can be between about 15 psi and about 30 psi, between about 30 psi and about 40 psi, about 40 psi, about 35 psi, about 30 psi, about 25 psi, about 20 psi, or a value in a range between any of the foregoing values. The reduced nozzle pressure can lower the reaction force imparted on the hose operator, thereby reducing the fatigue of the operator aiming and handling the hose 101 and nozzle assembly 300 and thus reducing the chance of the operator losing control of the nozzle assembly 300. Additionally, the stiffer hose 101 near the nozzle assembly 300 reduces kinking in the hose 101 and provide greater stability. The presence of the flow conditioner 334 reduces turbulence in the stream, so any instabilities in the flow path are reduced/eliminated in the downstream direction relatively quickly, enabling the overall length of the nozzle assembly 300 to be relatively short in the axial direction, which leads to material savings, reduced weight, and easier control and maneuverability of the nozzle assembly 300.

In the embodiment illustrated in FIGS. 6A and 6B, the backpressure booster is incorporated into the nozzle assembly upstream of the shut-off valve assembly. In other embodiments, however, the backpressure booster can be incorporated into the nozzle assembly in a different position.

With reference to FIGS. 7A and 7B, for example, in some embodiments, the backpressure booster 430 is coupled between the shut-off valve assembly 402 and the nozzle 404. FIG. 7A is a side view of a nozzle assembly 400 attached to the hose 101 and FIG. 7B is a cross-sectional view of the nozzle assembly 400 and the hose 101, where the nozzle assembly 400 includes a backpressure booster 430 releasably (and fluidly) coupled between the shut-off valve assembly 402 and the nozzle 404. Except for the inclusion of the backpressure booster 430, the nozzle assembly 400 can be otherwise similar or identical to the nozzle assembly 100 shown and described above in connection with FIGS. 1 and 2, with reference numbers incremented by 300. Similarly, the backpressure booster 430 can be similar or identical to backpressure boosters 130, 230 shown and described above in connection with FIGS. 3A-5, with reference numbers incremented by 300 and 200, respectively.

The backpressure booster 430 is incorporated into the nozzle assembly 400 downstream of the shut-off valve assembly 402 and upstream of the nozzle 404. The inlet 440 and the outlet 442 of the backpressure booster 430 each include threading, where the threading of the inlet 440 is releasably attached to threading at the downstream end of the shut-off valve assembly 402 and the threading of the outlet 442 is releasably attached to the threading at the upstream end of the nozzle 404. It will be understood that connection mechanisms other than threading can be employed. In this embodiment, the fluid flows from the hose 101 into the shut-off valve assembly 402 (via the hose coupling section 407 configured to connect to the hose 101 configured for firefighting applications). When the valve 410 is in an open position, the fluid flows through valve portion 406 of the shut-off valve assembly 402 and into the backpressure booster 430 (via the inlet 440). The fluid passes through the flow restrictor 432 and then around the flow conditioner 434 before exiting the backpressure booster 430 (via the outlet 442). The fluid then passes into the nozzle 404 and then exits the nozzle assembly 400 via the nozzle 404. Positioning the backpressure booster 430 downstream of the shut-off valve assembly 402 can be useful in that it is relatively easy to couple and remove the backpressure booster 430 from the nozzle assembly 400, as the shut-off valve assembly 402 can be closed to enable coupling (or removing) the backpressure booster 430 from the nozzle assembly 400. In this way, it can be easier to remove the backpressure booster 430 from the shut-off valve assembly 402 in the field to clean the backpressure booster 430 if it gets clogged without having to depressurize the hose 101.

### Nozzle Assemblies Having an Integrated Backpressure Booster

In the embodiments illustrated in FIGS. 6A-7B, the backpressure boosters are releasably incorporated into the nozzle assemblies using threading (or some other releasable attachment means) at the inlet and outlet of the backpressure boosters, thereby allowing the backpressure booster to be incorporated into conventional nozzle assemblies. However, forming the backpressure booster as a separate component can increase cost, weight, length, and complexity, and can introduce failure modes to the nozzle assembly. Accordingly, in some embodiments, the backpressure booster can be integrally formed with one or components of the nozzle assembly, such as the shut-off valve assembly or the nozzle, in a manner that is not reversible without the use of tools or damage to the assembly.

FIG. 8A is a side view of a shut-off valve assembly 502 that includes a valve portion 506 and a backpressure booster portion 530 coupled to the valve portion 506 and FIG. 8B is a cross section of the shut-off valve assembly 502. The valve portion 506 includes an actuator 508 and a valve 510 connected to the actuator 508, where the valve portion 506, actuator 508, and valve 510 are generally similar to the valve portion 106, actuator 108, and valve 110 shown and described above in connection with FIGS. 1 and 2. The backpressure booster portion 530 is shown positioned upstream from the valve 510 and includes a flow restrictor 532 and a flow conditioner 534. The flow restrictor 532 and the flow conditioner 534 can be generally similar to the flow restrictors 132, 232 and flow conditioners 134, 234 shown and described above in connection with FIGS. 3A-5. The backpressure booster portion 530 can include threading or other connection mechanism configured to releasably attach to a hose to securely couple the shut-off valve assembly 502 to the hose 101. In some embodiments, the backpressure booster portion 530 is manufactured as a separate component than the valve portion 506 but is securely and rotationally coupled to the valve portion 506 so that the valve portion 506 can freely rotate or swivel relative to the backpressure booster portion 530, and thus relative to the hose. In some embodiments, the backpressure booster portion 530 can be integrated with the valve portion 506 such that the backpressure portion 530 cannot be detached or decoupled from the valve portion 506 without permanently altering, deforming, or destroying a portion of the shut-off valve assembly 502 and/or without using a tool or other external apparatus. In some embodiments, the backpressure booster portion 530 can be integrated with the valve portion 506 such that an operator of the shut-off valve assembly 502 cannot easily detach or decouple the backpressure booster portion 530 from the valve portion 506 in the field during a firefighting operation. In other embodiments, however, the backpressure booster portion can be independent and reversibly connected (e.g., without tools) to the valve portion 506. In some embodiments, the backpressure booster portion 530 is press fit into the valve portion 506. To facilitate the rotational movement of the valve portion 506 relative to the backpressure booster portion 530, the shut-off valve assembly 502 can include bearings and a sealing member (e.g., an O-ring) between the backpressure booster portion 530 and the valve portion 506. In some embodiments, at least a portion of the backpressure booster portion 530 and at least a portion of the valve portion 506 can be formed (e.g., molded or cast) as a single or monolithic component. In some embodiments, the shut-off valve assembly 502 can have a housing that at least partially defines the backpressure booster portion 530 and the valve portion 506. The flow restrictor 532 and the flow conditioner 534 can be positioned within the housing and the housing can define an inner surface 544 of the backpressure booster portion 530. The housing of the shut-off valve assembly 502 can also at least partially define the size and shape of one or both of the valve 510 and an outlet of the valve shut-off valve assembly 502.

During operation of the shut-off valve assembly 502, fluid enters the backpressure booster portion 530 and passes through the opening 536 of the flow restrictor 532. The flow restrictor 532 restricts the flow of the fluid, resulting in increased pressure at locations upstream from the shut-off valve assembly 502. After passing through the opening 536, the fluid flows around the flow conditioner 534, which diverts the fluid radially outward towards the inner surface 544 of the backpressure booster portion 530 to squeeze out and reduce or eliminate eddies formed by the flow restrictor 532 and/or the flow conditioner 534. A converging section 564 of the backpressure booster 530 directs the fluid radially inwardly as the fluid approaches the valve portion 506 to further laminarize the flow. The fluid passes through the valve portion 506 (when the valve 510 is in an open configuration) and then leaves shut-off valve assembly 502.

The presence of the backpressure booster portion 530 within the shut-off valve assembly 502 can increase the pressure in the hose near the shut-off valve assembly 502 and can create a pressure drop within the shut-off valve assembly, resulting in both a stiffer hose that is easier to control and less prone to kinking and lower reaction force that reduces fatigue of the of the hose operator. Additionally, integrating the backpressure booster portion 530 into the shut-off valve assembly 502 can reduce costs, weight, length, complexity, and failure modes of the entire nozzle assembly. Although illustrated as integrated upstream of the shut-off valve portion 506, it will be understood that the backpressure booster portion can instead be integrated downstream of the valve portion 506 to obtain the benefits of that position described above with respect to FIGS. 7A-7B, such as allowing access to the restricted flow path within the backpressure booster portion, for example for clearing out any obstructions, in the field while the shut-off valve is in the closed position.

FIG. 9A is a side view of a nozzle 604 having a nozzle portion 605 and a backpressure booster portion 630 coupled to the nozzle portion 605 and FIG. 9B is a cross section of the nozzle 604. In some embodiments, including the illustrated embodiment, the nozzle portion 605 includes a converging section 616 positioned downstream of the backpressure booster portion 630, a transition section 618 positioned downstream of the converging section 616, a hybrid section 620 positioned downstream of the transition section 618, a flow modulation section 622 positioned downstream of the hybrid section 620, and optional control arms (not shown). The flow modulation section 622 and the optional control arms can be similar to flow modulation section 122 and optional control arms shown and described in connection with FIG. 2. In other embodiments, however, the nozzle portion 605 may not include one or more of the converging section 616, the transition section 618, the hybrid section 620, the flow modulation section 622 and/or the control arms. The nozzle portion 605 can also include other or additional sections, component or the like beyond those shown and described herein.

The backpressure booster portion 630 is shown positioned upstream from the nozzle portion 605 and includes a flow restrictor 632 and a flow conditioner 634. The flow restrictor 632 and the flow conditioner 634 can be generally similar to the flow restrictors 132, 232 and flow conditioners 134, 234 shown and described above in connection with FIGS. 3A-5. The backpressure booster portion 630 can include threading or other connection mechanism configured to releasably attach to a shut-off valve assembly (such as shut-off valve assemblies 102, 302, and 402) to securely couple the nozzle 604 to the shut-off valve assembly. In some embodiments, the backpressure booster portion 630 is manufactured as a separate component than the nozzle portion 605 but is securely and rotationally coupled to the nozzle portion 605 so that the nozzle portion 605 can freely rotate or swivel relative to the backpressure booster portion 630, and thus relative to the hose. In some embodiments, the backpressure booster portion 630 can be integrated with the nozzle portion 605 such that the backpressure portion 630 cannot be detached or decoupled from the nozzle portion 605 without permanently altering, deforming, or destroying a portion of nozzle 604 and/or without using a tool or other external apparatus. For example, the backpressure booster portion 630 can be integrated with the nozzle portion 605 such that an operator of the nozzle 604 cannot easily detach or decouple the backpressure booster portion 630 from the nozzle 605 in the field during a firefighting operation. In other embodiments, however, the backpressure booster portion can be independent and reversibly connected (e.g., without tools) between a shut-off valve and the nozzle. In some embodiments, the backpressure booster portion 630 is press fit into the nozzle portion 605. To facilitate the rotational movement of the nozzle portion 605 relative to the backpressure booster portion 630, the nozzle 604 can include bearings and a sealing member (e.g., an O-ring) between the backpressure booster portion 630 and the nozzle portion 605. In some embodiments, at least a portion of the backpressure booster portion 630 and at least a portion of the nozzle portion 605 can be formed (e.g., molded or cast) as a single component. In some embodiments, the nozzle 604 can have a housing that at least partially defines the backpressure booster portion 630 and the nozzle portion 605. The flow restrictor 632 and the flow conditioner 634 can be positioned within the housing and the housing can define an inner surface 644 of the backpressure booster portion 630. The housing of the nozzle 604 can also at least partially define the size and shape of one or more of the converging section 616, the transition section 618, the hybrid section 620, and the flow modulation section 622.

During operation of the nozzle 604, fluid enters the backpressure booster portion 630 and passes through the opening 636 of the flow restrictor 632. The flow restrictor 632 restricts the flow of the fluid, resulting in increased pressure at locations upstream from the nozzle 604. After passing through the opening 636, the fluid flows around the flow conditioner 634, which diverts the fluid radially outward towards the inner surface 644 of the backpressure booster portion 630 to squeeze out and reduce or eliminate eddies formed by the flow restrictor 632 and/or the flow conditioner 634. The fluid passes then passes into the nozzle portion 605 and flows through the converging section 616, transition section 618, and hybrid section 620 before being sprayed outward.

The presence of the backpressure booster portion 630 within nozzle 604 can increase the fluid pressure upstream from nozzle 604 (including in the hose) and can create a pressure drop within the nozzle 604, resulting in both a stiffer hose that is easier to control and less prone to kinking and lower reaction force that reduces fatigue of the of the hose operator. Additionally, integrating the backpressure booster portion 630 into the nozzle 604 can reduce costs, weight, length, complexity, and failure modes of the entire nozzle assembly.

In some embodiments, including the illustrated embodiment, the backpressure booster portion 630 is upstream from the nozzle portion 605 and the nozzle 604 does not include an additional component between the nozzle portion 605 and the backpressure booster portion 630. In other embodiments, however, the nozzle 604 can include a stream straightener positioned between the flow restrictor 632 and the nozzle outlet, such as an insert in the downstream portion of the backpressure booster portion 630 or the upstream portion of the nozzle portion 605. The stream straightener can include one or more openings through which fluid can flow after passing through the flow conditioner 634. As the fluid flows through the openings, the stream straightener can streamline the flow more quickly, which can reduce the overall length and weight of the nozzle 604 for a given stream quality as it leaves the nozzle 604.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

1. A backpressure booster for a nozzle assembly, the backpressure booster comprising:
a housing;
a flow restrictor within the housing; and
a flow conditioner within the housing and positioned downstream from the flow restrictor, wherein the flow conditioner is configured to direct fluid radially outward towards an inner surface of the housing.

2. The backpressure booster of claim 1, wherein the flow restrictor comprises an opening having a first cross-sectional area, wherein the inner surface of the housing at a position upstream from the opening has a second cross-sectional area, and wherein the first cross-sectional area is less than the second cross-sectional area.

3. The backpressure booster of claim 2, wherein the first cross-sectional area is between about 25% and about 55% of the second cross-sectional area.

4. The backpressure booster of claim 1, wherein the flow restrictor comprises an opening have a first diameter, wherein the inner surface of the housing at a position upstream from the opening has a second diameter, and wherein the first diameter is less than the second diameter.

4. inal) The backpressure booster of claim 4, wherein the first diameter is between about 50% and about 75% of the second diameter.

6. The backpressure booster of claim 1, wherein the flow conditioner comprises a body having an upstream portion and a downstream portion.

7. The backpressure booster of claim 6, wherein a maximum cross-sectional area of the body is between about 25% and about 55% of a cross-sectional area of the inner surface at a position downstream of the flow restrictor.

8. The backpressure booster of claim 6, wherein the flow conditioner comprises one or more arms and wherein the body is coupled to the housing with the one or more arms.

9. The backpressure booster of claim 6, wherein the upstream portion has a conical shape and wherein a surface of the upstream portion is angled to direct the fluid radially outward towards the inner surface.

10. The backpressure booster of claim 9, wherein the upstream portion forms an angle with a central axis of the backpressure booster of between about 45° and 75°.

11. The backpressure booster of claim 6, wherein the downstream portion has a conical shape.

12. The backpressure booster of claim 6, wherein the backpressure booster has a cylindrical shape.

13. A nozzle assembly, comprising:
a nozzle;
a valve assembly positioned upstream from the nozzle; and
a backpressure booster positioned upstream from the nozzle, wherein the backpressure booster comprises:
a housing;
a flow restrictor within the housing; and
a flow conditioner within the housing and positioned downstream from the flow restrictor, wherein the flow conditioner is configured to direct fluid radially outward towards an inner surface of the housing.

14. The nozzle assembly of claim 13, wherein the backpressure booster is positioned upstream from the valve assembly.

15. The nozzle assembly of claim 13, wherein the backpressure booster is positioned downstream from the valve assembly.

16. The nozzle assembly of claim 13, wherein the backpressure booster is releasably coupled to the valve assembly.

17. The nozzle assembly of claim 13, wherein the nozzle assembly is fluidly coupled to a hose configured to provide a fluid to the nozzle assembly and wherein a nozzle pressure is between about 20% and about 70% of the hose pressure.

18. A valve assembly for a nozzle assembly, wherein the valve assembly comprises:
a valve portion; and
a backpressure booster portion integrally formed with and fluidly coupled to the valve portion, wherein the backpressure booster portion comprises:
a flow restrictor; and
a flow conditioner and positioned downstream from the flow restrictor, wherein the flow conditioner is configured to direct fluid radially outward towards an inner surface of the backpressure booster portion.

19. The valve assembly of claim 18, wherein the backpressure booster portion is positioned upstream from the valve portion.

20. The valve assembly of claim 18, wherein the backpressure booster portion is positioned downstream from the valve portion.

21. The valve assembly of claim 18, wherein the backpressure booster portion is releasably coupled to the valve portion.

22. The valve assembly of claim 18, wherein the valve portion and the backpressure booster portion are integrally formed together such that the backpressure booster portion cannot be detached from the valve portion without deforming one or both of the backpressure booster portion and the valve portion or without using a tool.

23. (canceled)

24. (canceled)

25. (canceled)
